(19) United States
(12) Patent Application Publication
(10) Pub. No.: US 2004/0223436 A1
(43) Pub. Date: Nov. 11, 2004

(54) Method and system for determining disc track pitch

(76) Inventor: Chun-Hsiang Tsai, Taoyuan County (TW)

Correspondence Address: BIRCH STEWART KOLASCH & BIRCH, PO BOX 747, FALLS CHURCH, VA, 22040-0747, US

(21) Appl. No.: 10/661,642

(22) Filed: Sep. 15, 2003

(30) Foreign Application Priority Data
May 8, 2003 (TW) 092112531

(51) Int. Cl. G11B 7/00

(52) U.S. Cl. 369/53.22

(57) ABSTRACT

A method of determining disc track pitch. First, a first frame count of one revolution corresponding to a first position with a first radius to a disc center is counted, and first time information of the first position is read. Then, a second frame count of one revolution corresponding to a second position is counted, and second time information of the second position is read. Then, a second radius corresponding to the second position to the disc center is calculated according to the first frame count, the second frame count and the first radius. A track pitch of the disc is calculated according to the first radius, the second radius, the first time information, the second time information and a linear velocity.

### BACKGROUND OF THE INVENTION

1. Field of the Invention

The present invention relates to a method and system for determining disc track pitch, and particularly to a method and system that accurately determines the track pitch of discs, thereby preventing inaccurate track number caused by imprecise optical reading, noise, and surface irregularity.

2. Description of the Related Art

With the development of optical storage media, data can be recorded and backed up in high capacity, lighter discs. Disc devices such as CD-ROM drives are becoming essential equipment in computer systems and electronic multimedia devices.

The disc device allows users to select a specific part of the disc to read, and the disc device may read data at any arbitrary position on the disc. The disc device first calculates the distance between the optical head of the disc device and the designated position of the disc according to the time information of the designated position, and then moves and fine tunes the optical head to the designated position to read data using a sled motor and a voice coil motor of the disc device according to the distance.

In the above procedure, a standard track pitch (1.6 μm) is used for the distance calculation. However, since there are many types of discs, the track pitch of each disc may be different (1.3 μm˜1.6 μm) based on its capacity. Therefore, if the standard track pitch is used to calculate the distance for all types of disc, the distance inaccuracy will be more serious, thereby increasing the time spent seeking the designated position, and delaying the response of the disc device. In addition, if the distance is calculated using a track counting function provided by the disc device, the result may be inaccurate due to noise or surface irregularities on the disc.

### SUMMARY OF THE INVENTION

It is therefore an object of the present invention to provide a method and system for determining disc track pitch that prevents the inaccurate track number caused by imprecise optical reading, noise, and surface irregularity.

To achieve the above object, the present invention provides a method and system of determining disc track pitch. The system includes an optical head and a processor to perform the disc track pitch detection according to the present invention.

The method of disc track pitch detection according to the present invention first counts a first frame count of one revolution corresponding to a first position with a first radius to a disc center, and reads first time information of the first position. The first radius is the distance from a beginning position of a data area of the disc to the disc center. Then, the method counts a second frame count of one revolution corresponding to a second position with a second radius to the disc center, and reads second time information of the second position.

Then, the second radius corresponding to the second position to the disc center is calculated according to the first frame count, the second frame count, and the first radius. Thereafter, a track pitch of the disc is calculated according to the first radius, the second radius, the first time information, the second time information and a linear velocity.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating the architecture of the system for disc track pitch detection according to the present invention;

FIG. 2 is a flowchart showing the method for disc track pitch detection according to the present invention;

FIG. 3 is a schematic diagram illustrating a disc; and

FIG. 4 is a schematic diagram illustrating another disc.

### DETAILED DESCRIPTION OF THE INVENTION

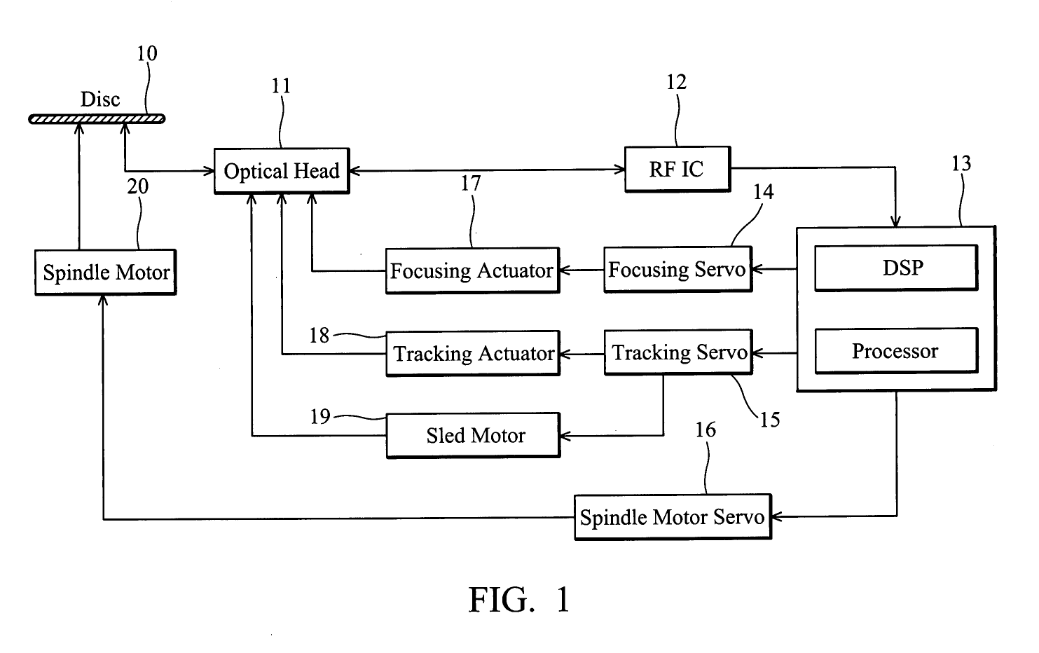

FIG. 1 illustrates the architecture of the system for disc track pitch detection according to the present invention. In the embodiment, the system may be a disc servo system, that is, the disc device may be applied in a CD-ROM, VCD-ROM, CD-RW ROM, DVD-ROM or DVD-RW ROM drive or player.

The optical head 11 reads a reflected signal from the disc 10. After the signal is amplified and processed by RF (Radio Frequency) IC 12, the FE (Focus Error) signal, TE (Tracking Error) signal and relative data and signals are input to the DSP (Digital Signal Processor) and processor 13.

After the processor 13 analyzes the received data and computes related operations, servo driver signals are computed and output to corresponding servos (focusing servo 14, tracking servo 15 and spindle motor servo 16) to control the actuators (focusing actuator 17, tracking actuator 18, sled motor 19 and spindle motor 20) to ensure accuracy when reading or writing data. The processor 13 performs the method of disc track pitch detection according to the present invention.

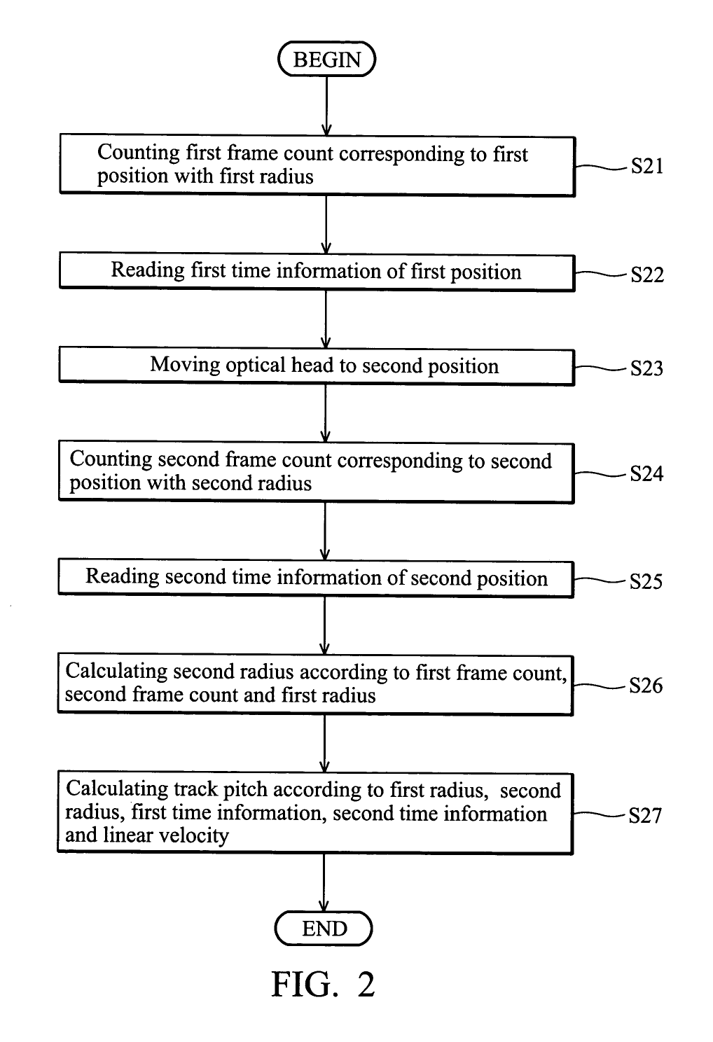

FIG. 2 shows the process of the method for disc track pitch detection according to the present invention. The embodiment of the present invention is suitable for use in optical disc and optical disc devices such as CD-ROM, VCD-ROM, CD-RW ROM, DVD-ROM or DVD-RW ROM drive or player.

First, in step S21, the processor 13 counts a first frame count F₀ of one revolution corresponding to a first position with a first radius (distance) r₀ to a disc center, in which the radius is the distance from the specific position to the disc center.

In addition, most processors may provide calculation of the frame count of one revolution, and record it in a frame counter. The processor 13 determines whether the disc makes a revolution by checking the number of waves returned by the sensor of the spindle motor 20. If the number of the waves equals a predetermined number, it means the disc has made a revolution. It should be noted that the predetermined number may differ due to the processors and components used in the different disc devices.

Then, in step S22, the processor 13 enables the optical head 11 to read first time information N₀ of the first position. Generally, the time information is recorded in the Q-Code.

Afterward, in step S23, the processor 13 drives the optical head 11 arbitrarily, to a second position. Then, in step S24, the processor 13 counts a second frame count F₁ of one revolution corresponding to the second position, and in step S25, reads second time information N₁ of the second position.

Thereafter, in step S26, the processor 13 calculates a second radius r₁ corresponding to the second position to the disc center according to the first frame count F₀, the second frame count F₁ and the first radius r₀. The frame count of one revolution F equals:

$$F = \frac{2 π r}{v} \times 75 \times 98 ,$$

in which 2πr is the circumference of a revolution, v is the linear velocity of the disc device (tangent velocity when writing data), and generally, there are 75 blocks in a second and 98 frames in a block, respectively.

In this case,

$${F}_{0} = \frac{2 π {r}_{0}}{v} \times 75 \times 98 , \qquad {F}_{1} = \frac{2 π {r}_{1}}{v} \times 75 \times 98 ,$$

and

$$\frac{{F}_{1}}{{F}_{0}} = \frac{{r}_{1}}{{r}_{0}} .$$

Therefore, the second radius r₁ corresponding to the second position can be obtained from the following equation (1):

$${r}_{1} = \frac{{F}_{1}}{{F}_{0}} \times {r}_{0} .$$

It should be noted that, in this case, the first radius r₀ is the distance from a beginning position of a data area of the disc to the disc center. That is, the first radius r₀ is a standard distance, such as 2.5 cm. In this case, the first time information is 0 min. 0 sec., and the step of reading the first time information N₀ of the first position in step S22 can be omitted. At this time, since the first frame count F₀, the second frame count F₁ and the first radius r₀ are known, the second radius r₁ can be obtained from the equation (1).

Thereafter, in step S27, the processor 13 calculates a track pitch p of the disc according to the first radius r₀, the second radius r₁, the first time information N₀, the second time information N₁ and the linear velocity v.

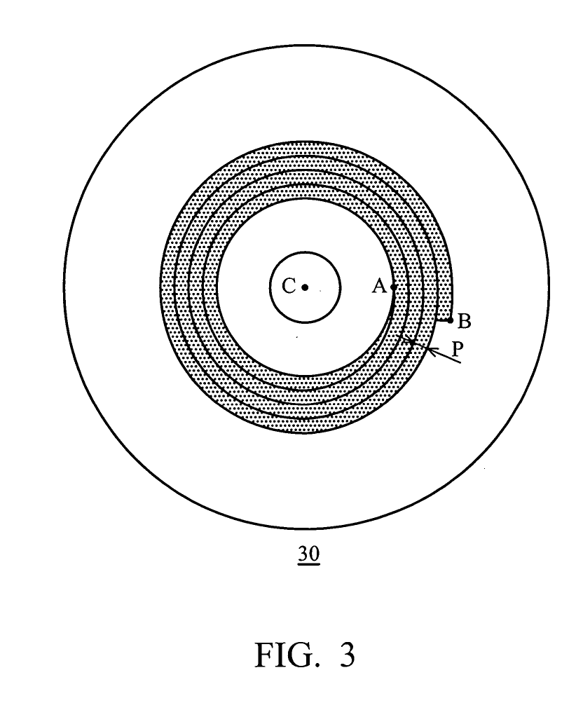

Referring to FIG. 3, FIG. 3 shows a schematic of a disc 30. In the disc 30, A represents the first position, B represents the second position, C represents the disc center, and p represents the track pitch of the disc 30. The area between the first position A and the second position B is the length of the track from the first position A to the second position B ((N₁−N₀)×60×v) multiplying the track pitch p, that is the area can be obtained using equation (2): ((N₁−N₀)×60×v)×p.

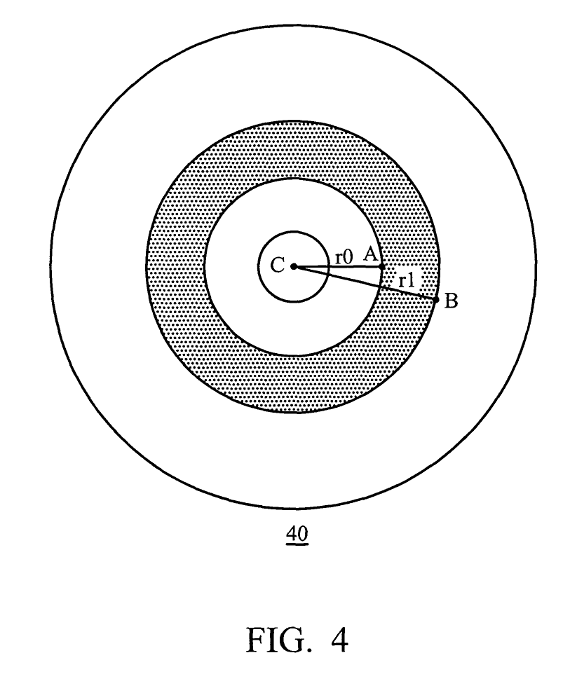

In addition, FIG. 4 shows a schematic of another disc 40. Similarly, A represents the first position, B represents the second position, C represents the disc center, r₀ represents the first radius between the first position A and the disc center C, and r₁ represents the second radius between the second position B and the disc center C. The area between the first position A and the second position B is the area between the second position B and the disc center C subtracting that between the first position A and the disc center C, such that the area can be obtained using equation (3): πr₁²−πr₀².

Since the area calculated from the equation (2) substantially equals the area calculated from the equation (3), that is ((N₁−N₀)×60×v)×p=πr₁²−πr₀². Therefore, the track pitch p can be obtained using the following equation (4):

$$p = \frac{π {r}_{1}^{2} - π {r}_{0}^{2}}{( {N}_{1} - {N}_{0} ) \times 60 \times v} .$$

As described above, since the first radius r₀ and the linear velocity v are known, the first time information No and the second time information N₁ are obtained in step S22 and S25 respectively, and the second radius r₁ is obtained from the equation (1) in step S26, the track pitch p of the disc can be obtained from the equation (4).

After the track pitch is obtained accurately, the disc device may directly calculate the distance between a specific position designated by users and the current position of the optical head, moves and fine tunes the optical head to the designated position to read data using the sled motor and the voice coil motor of the disc device according to the distance, thereby reducing the inaccuracy when seeking the designated position. More precisely, the track number that the optical head needs to move can be obtained by the distance (radius difference) of the first position A and the second position B dividing the track pitch p, and the sled motor and the voice coil motor can move and fine tune the optical head according to the track number.

As a result, using the method and system for disc track pitch detection according to the present invention, the incorrect track number resulting in the inaccuracy, including imprecise optical reading, noise, and surface irregularity can be prevented, meanwhile reducing the time spent seeking the designated position, and speeding the response of the disc device.

Although the present invention has been described in its preferred embodiments, it is not intended to limit the invention to the precise embodiments disclosed herein. Those skilled in the technology can still make various alterations and modifications without departing from the scope and spirit of this invention. Therefore, the scope of the present invention shall be defined and protected by the following claims and their equivalents.

What is claimed is:

1. A method of determining a track pitch of a disc in a disc drive, comprising the steps of:
reading first time information and counting a first frame count of one revolution at a predetermined first position with a first radius to the center of the disc;
reading second time information and counting a second frame count of one revolution at a second position with a second radius to the center of the disc;
calculating the second radius according to the first frame count, the second frame count and the first radius; and
calculating a track pitch of the disc according to the first radius, the second radius, the first time information, the second time information and a linear velocity of the disc drive.

2. The method as claimed in claim 1 wherein the first radius is the distance from a beginning position of a data area of the disc to the disc center.

3. The method as claimed in claim 1 wherein the second radius is calculated according to the following equation,
$${r}_{1} = \frac{{F}_{1}}{{F}_{0}} \times {r}_{0} ,$$
wherein r₁ is the second radius, r₀ is the first radius, F₀ is the first frame count, and F₁ is the second frame count.

4. The method as claimed in claim 1 wherein the first time information and the second time information are recorded in Q-Code.

5. The method as claimed in claim 1 wherein the track pitch is calculated according to the following equation,
$$p = \frac{π {r}_{1}^{2} - π {r}_{0}^{2}}{( {N}_{1} - {N}_{0} ) \times 60 \times v} ,$$
wherein p is the track pitch, r₀ is the first radius, r₁ is the second radius, N₀ is the first time information, N₁ is the second time information, and v is the linear velocity.

6. A disc drive, comprising:
an optical head; and
a processor used to perform the steps of:
moving the optical head to a first position with a first radius to the center of a disc;
reading first time information and counting a first frame count of one revolution;
moving the optical head to a second position with a second radius to the center of the disc;
reading second time information and counting a second frame count of one revolution;
calculating the second radius according to the first frame count, the second frame count and the first radius; and
calculating a track pitch of the disc according to the first radius, the second radius, the first time information, the second time information and a linear velocity of the disc drive.

7. The disc drive as claimed in claim 6, wherein the first radius is the distance from a beginning position of a data area of the disc to the disc center.

8. The disc drive as claimed in claim 6 wherein the second radius is calculated according to the following equation,
$${r}_{1} = \frac{{F}_{1}}{{F}_{0}} \times {r}_{0} ,$$
wherein r₁ is the second radius, r₀ is the first radius, F₀ is the first frame count, and F₁ is the second frame count.

9. The disc drive as claimed in claim 6 wherein the first time information and the second time information are recorded in Q-Code.

10. The disc drive as claimed in claim 6 wherein the track pitch is calculated according to the following equation,
$$p = \frac{π {r}_{1}^{2} - π {r}_{0}^{2}}{( {N}_{1} - {N}_{0} ) \times 60 \times v} ,$$
wherein p is the track pitch, r₀ is the first radius, r₁ is the second radius, N₀ is the first time information, N₁ is the second time information, and v is the linear velocity.

11. A method for determining disc track pitch, for use in a disc device, comprising the steps of:
counting a first frame count of one revolution corresponding to a first position with a first radius to a center of a disc, in which the first radius is the distance from a beginning position of a data area of the disc to the disc center;
counting a second frame count of one revolution corresponding to a second position with a econd radius to the center of the disc;
calculating the second radius according to the first frame count, the second frame count and the first radius;
reading second time information of the second position; and
calculating a track pitch of the disc according to the first radius, the second radius, the second time information and a linear velocity;
wherein the first radius is the distance from a beginning position of a data area of the disc to the disc center.

12. The method for determining disc track pitch as claimed in claim 11 wherein the second radius is calculated according to the following equation,
$${r}_{1} = \frac{{F}_{1}}{{F}_{0}} \times {r}_{0} ,$$
wherein r₁ is the second radius, r₀ is the first radius, F₀ is the first frame count, and F₁ is the second frame count.

13. The method for determining disc track pitch as claimed in claim 11 wherein the second time information is recorded in Q-Code.

14. The method for determining disc track pitch as claimed in claim 11 wherein the track pitch is calculated according to the following equation,
$$p = \frac{π {r}_{1}^{2} - π {r}_{0}^{2}}{{N}_{1} \times 60 \times v} ,$$
wherein p is the track pitch, r₀ is the first radius, r₁ is the second radius, N₁ is the second time information, and v is the linear velocity.

15. A method for determining disc track pitch, for use in a disc device having an optical head moving according to a track pitch, said method comprising the steps of:
counting a first frame count of one revolution corresponding to a first position with a first radius to a center of a disc;
reading first time information of the first position;
counting a second frame count of one revolution corresponding to a second position with a second radius to the center of the disc;
reading second time information of the second position;
calculating the second radius according to the first frame count, the second frame count and the first radius; and
calculating a track pitch of the disc according to the first radius, the second radius, the first time information, the second time information and a linear velocity.
